(19) United States
(12) Patent Application Publication
(10) Pub. No.: US 2009/0018301 A1
(43) Pub. Date: Jan. 15, 2009

(54) HETEROGENEOUS HYDROSILYLATION CATALYSTS, POLYMERS FORMED THEREWITH, AND RELATED COATING COMPOSITIONS

(76) Inventors: Stephen J. Thomas, Aspinwall, PA (US); William H. Retsch, JR., Allison Park, PA (US); Pyotr M. Valetsky, Moscow (RU); Stanislav N. Sidorov, Moscow (RU); Yurii A. Kabachii, Moscow (RU); Irina B. Tsvetkova, Moscow (RU)

Correspondence Address: PPG INDUSTRIES INC;INTELLECTUAL PROPERTY DEPT, ONE PPG PLACE, PITTSBURGH, PA, 15272, US

(21) Appl. No.: 11/684,198

(22) Filed: Mar. 9, 2007

Related U.S. Application Data
(60) Provisional application No. 60/781,268, filed on Mar. 10, 2006.

(51) Int. Cl. C08G 77/08; B01J 23/40; B01J 23/42; B01J 31/06

(52) U.S. Cl. 528/15; 502/325; 502/339; 502/159

(57) ABSTRACT

Disclosed are heterogeneous platinum group metal catalysts that are catalytically active towards hydrosilylation. These catalysts include a carrier in communication with platinum group metal particles, wherein the particles are affixed to a polyelectrolyte layer. Also disclosed are polymers that are the hydrosilylation reaction product of (a) a polysiloxane containing silicon hydride and (b) an organic compound having aliphatic unsaturation in the molecule, wherein the hydrosilylation reaction is carried out in the presence of a catalytic amount of such a catalyst, a heterogeneous platinum group metal catalyst that is catalytically active towards hydrosilylation, coating compositions that include such polymers and substrates at least partially coated with such compositions.

### CROSS-REFERENCE TO RELATED APPLICATIONS

This application claims the benefit of U.S. Provisional Patent Application Ser. No. 60/781,268, filed Mar. 10, 2006, which is incorporated by reference herein in its entirety.

### FIELD OF THE INVENTION

The present invention relates to heterogeneous hydrosilylation catalysts, polymers formed as a result of a hydrosilylation reaction utilizing such a catalyst, and coating compositions comprising such polymers.

### BACKGROUND OF THE INVENTION

The addition of Si—H groups onto aliphatic multiple bonds is known as hydrosilylation. This reaction is often promoted by, for example, a homogeneous or heterogeneous platinum group metal catalyst. Homogeneous platinum group metal catalysts are often more active than their heterogeneous counterparts, however, such catalysts are normally in the form of a solution and they are, by definition, interspersed among the initial reactants, making subsequent separation of the catalyst from the polymeric solution difficult, if not impossible. As a result, discoloration of the polymer is difficult, if not impossible, to avoid.

Heterogeneous platinum metal catalysts conventionally have been either unsupported or supported on a carrier comprised of an inert solid material, such as a metal oxide, often alumina, or a base metal. In general, these heterogeneous catalysts, supported and unsupported, have the advantage of being easily removed from a reaction, such as by, for example, filtration. Such removal allows the catalyst to be reused and minimizes discoloration of the resultant polymer solution. Heterogeneous catalysts can be physically attached or fixed in different locations in the equipment in which the reaction is conducted. Heterogeneous catalysts are also susceptible to chemical promotion or activity modifications. Such catalysts, however, are generally disadvantageous because they have large agglomerates of metal and, therefore, a much lower level of catalytic activity as compared to their homogeneous counterparts. As a result, they are often not cost effective.

As a result, it would be desirable to provide a heterogeneous platinum group metal catalyst having an effective level of catalytic activity in a hydrosilylation reaction, while being easily removable from a polymeric solution and minimizing, and even eliminating, the discoloration thereof.

### SUMMARY OF THE INVENTION

In certain respects, the present invention is directed to heterogeneous platinum group metal catalysts that are catalytically active towards hydrosilylation. These catalysts comprise a carrier in communication with platinum group metal particles, wherein the particles are affixed to a polyelectrolyte layer.

In other respects, the present invention is directed to a polymer comprising the hydrosilylation reaction product of (a) a polysiloxane containing silicon hydride and (b) an organic compound having aliphatic unsaturation in the molecule, wherein the hydrosilylation reaction is carried out in the presence of a catalytic amount of a heterogeneous platinum group metal catalyst that is catalytically active towards hydrosilylation, wherein the catalyst comprises a carrier in communication with platinum group metal particles, wherein the particles are affixed to a polyelectrolyte layer.

In still other respects, the present invention is directed to a method for improving the color development of a coating composition comprising a polymer comprising the hydrosilylation reaction product of a polysiloxane containing silicon hydride and an organic compound having aliphatic unsaturation in the molecule. These methods comprise (a) carrying out the hydrosilylation reaction in a medium comprising a catalytic amount of a heterogeneous platinum group metal catalyst that is catalytically active towards hydrosilylation, wherein the catalyst comprises a carrier in communication with platinum group metal particles, wherein the particles are affixed to a polyelectrolyte layer; and (b) removing the catalyst from the medium.

The present invention is also directed to, for example, related coating compositions and coated substrates.

### DETAILED DESCRIPTION OF EMBODIMENTS OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. For example, the present invention refers to a “polyelectrolyte layer”. Such references will be understood herein to refer to a single polyelectrolyte layer as well as a plurality of such layers, i.e., a multilayer polyelectrolyte. In addition, in this application, the use of “or” means “and/or” unless specifically stated otherwise, even though “and/or” may be explicitly used in certain instances.

As indicated, certain embodiments of the present invention are directed to heterogeneous hydrosilylation catalysts. As used herein, the term “hydrosilylation catalyst” refers to materials that catalyze the reaction between molecules containing aliphatic unsaturation, i.e., C═C, and molecules containing silicon hydride, i.e., Si—H. As used herein, the term “heterogeneous hydrosilylation catalyst” refers to a hydrosilylation catalyst that is in a different phase from the reactants, e.g., a solid catalyst and liquid or gaseous reactants.

As previously indicated, certain embodiments of the present invention are directed to heterogeneous platinum group metal catalysts that are catalytically active towards hydrosilylation. As used herein, the phrase “catalytically active towards hydrosilylation” means that the platinum group metal catalysts disclosed herein significantly affect the rate of a hydrosilylation reaction, i.e., the presence of the heterogeneous platinum metal catalysts of the present invention in relatively small amounts, such as 0.05 to 5 percent by weight based on the total weight of the reactants, increase the rate of a hydrosilylation reaction such that the reaction can be substantially completed, i.e., at least 90% of the starting materials have been consumed, in a matter of, in some cases, a few minutes. It is believed that not all heterogeneous platinum group metal catalysts are catalytically active towards hydrosilylation.

In certain embodiments, the heterogeneous platinum group metal catalysts of the present invention comprise a carrier in communication with platinum group metal particles. As used herein, the term “in communication with” means that the platinum group metal particles are in contact with the carrier, either directly or through another material, such as the polyelectrolyte layer described herein.

As used herein, the term “carrier” refers to a material upon which and/or in which another material is supported. In certain embodiments, the carrier comprises a material that is inert to a hydrosilylation reaction and which is of appropriate size and ability to retain the platinum group metal particles. Examples of such materials, which are suitable for use in the present invention, are carbon, activated carbon, graphite, silica, silica gel, alumina, alumina-silica, and diatomaceous earth. The carrier can be in the form of, for example, particles, powder, flakes, chips, chunks, and pellets.

The size of the carrier may vary and, in certain embodiments, the carrier comprises particles having an average particle size of up to 10 millimeters, such as 1 micron up to 10 millimeters, or, in some cases, 50 microns to 1 millimeter.

The catalysts of the present invention comprise a “platinum group metal”. As used herein, the term “platinum group metal” refers to iridium, osmium, palladium, platinum, rhodium, and/or ruthenium. In certain embodiments, however, the platinum group metal particles comprise platinum.

In certain embodiments, the platinum group metal particles in communication with the carrier are ultrafine particles. As used herein, the term “ultrafine” refers to particles that have an average primary particle size of no more than 300 nanometers, such as no more than 100 nanometers, in some cases no more than 50 nanometers, or, in certain embodiments, no more than 20 nanometers, as determined by visually examining a micrograph of a transmission electron microscopy (“TEM”) image, measuring the diameter of the particles in the image, and calculating the average primary particle size of the measured particles based on magnification of the TEM image. One of ordinary skill in the art will understand how to prepare such a TEM image and determine the primary particle size based on the magnification. The primary particle size of a particle refers to the smallest diameter sphere that will completely enclose the particle. As used herein, the term “primary particle size” refers to the size of an individual particle as opposed to an agglomeration of two or more individual particles.

In certain embodiments, the platinum group metal particles in communication with the carrier are present in an amount of up to 3 percent by weight, such as 1 to 1.5 percent by weight, wherein the weight percents are based on the total weight of the heterogeneous hydrosilylation catalyst.

As indicated, in certain embodiments of the present invention, the platinum group metal particles are affixed to a polyelectrolyte layer. As used herein, the phrase “affixed to” means that the platinum group metal particles are physically attached to the polyelectrolyte layer. In certain embodiments, such particles are immobilized within the polyelectrolyte layer.

Notably, in the present invention, the polyelectrolyte layer to which the platinum group metal particles are affixed produces a heterogeneous platinum group metal catalyst that is catalytically active towards hydrosilylation, as described earlier. Indeed, the present inventors believe that not all polyelectrolyte layers would produce such a catalyst. Without being bound by any theory, the inventors believe that, to produce such a catalyst, the polyelectrolyte must be selected so as to entrain the catalytically active species such that the platinum group metal is not lost into the reaction solution, while, at the same time, not sterically, electronically or otherwise interfering with the catalytic activity of the platinum group metal.

As used herein, the term “polyelectrolyte layer” refers to a polymeric layer, wherein the polymer contains ionic constituents, either cationic or anionic. Such polymers can be, for example, linear or branched. In certain embodiments of the present invention, the polyelectrolyte is cationically charged. The particular polymer used to form the polyelectrolyte layer is not limiting, so long as the resultant heterogeneous platinum group metal catalyst is catalytically active towards hydrosilylation. A suitable cationic polyelectrolyte is poly(diallyldimethylammonium chloride) (PDADMAC). In certain embodiments of the present invention, the polyelectrolyte comprises PDADMAC having a weight average molecular weight of 400,000 to 500,000, such as Product No. 409030, which is commercially available from Sigma-Aldrich Co. Other polyelectrolytes that are believed to be suitable for use in the present invention include poly(allylamine hydrochloride), poly(ethyleneimine), poly(2-vinylpyridine), poly(4-vinylpyridine), polybiguanide, poly(1,2-dimethyl-5-vinylpyridinium Me sulfate), poly(methacryloyloxyethyl dimethylbenzylammonium chloride), polystyrene-b-polyacrylic acid, poly(sodium 4-styrenesulfonate), ammonium polymethylmethacrylate (Darvan C), ammonium polyacrylate, polyacrylic amine salt, sodium polyacrylate, and chitosan polysaccharides.

In certain embodiments, the polyelectrolyte is present in an amount of 6.5 to 30 percent by weight, such as 2 to 5 percent by weight, wherein the weight percents are based on the total weight of the heterogeneous hydrosilylation catalyst.

In certain embodiments, the heterogeneous platinum group metal catalysts of the present invention are made by a method comprising: (a) forming a carrier at least partially coated with a polyelectrolyte layer, (b) adding a platinum group metal complex into the polyelectrolyte layer, and (c) reducing the oxidation state of the platinum group metal catalyst by the addition of a reducing agent.

A suitable, but non-limiting, platinum metal complex for use in the foregoing method is H₂PtCl₆. A suitable, but non-limiting, reducing agent is hydrazine hydrate. Other reducing agents that are believed to be suitable for use in the present invention include, without limitation sodium borohydride and borane complexes.

As previously indicated, the present invention is also directed to polymers comprising the hydrosilylation reaction product of (a) a polysiloxane containing silicon hydride and (b) an organic compound having aliphatic unsaturation in the molecule. As used herein, “siloxane” means a group comprising a backbone comprising two or more —SiO— groups.

In certain embodiments, the polysiloxane containing silicon hydride comprises a compound having the structure:

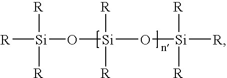

wherein each substituent group R, which may be identical or different, represents a group selected from H, OH, a monovalent hydrocarbon group, and mixtures of any of the foregoing; at least one of the groups represented by R is H, and n′ ranges from 0 to 100, such as 0 to 10, or, in some cases, 0 to 5, such that the percent of Si—H content of the polysiloxane ranges from 2 to 50 percent, such as 5 to 25 percent. Examples of a polysiloxane containing silicon hydride are 1,1,3,3-tetramethyl disiloxane and polysiloxane containing silicon hydrides where n is 4 to 5, commercially available from BASF as MASILWAX BASE.

As previously indicated, in the hydrosilylation reaction of the present invention, the polysiloxane containing silicon hydride is reacted with an organic compound having aliphatic unsaturation in the molecule. Non-limiting specific examples of such materials, which are suitable for use in the present invention, are described in U.S. Pat. No. 4,614,812 at col. 5, lines 7 to 28, the cited portion of which being incorporated by reference herein. In certain embodiments, the organic compound having aliphatic unsaturation in the molecule comprises at least one functional group selected from a hydroxyl group, a thiol group, a carboxyl group, an isocyanate group, a blocked isocyanate group, a primary amine group, a secondary amine group, an amide group, a carbamate group, a urea group, a urethane group, a vinyl group, an unsaturated ester group, such as an acrylate group and/or a methacrylate group, a maleimide group, a fumarate group, an onium salt group, such as a sulfonium group and/or an ammonium group, an anhydride group, a hydroxy alkylamide group, and an epoxy group. Specific examples of such materials, which are suitable for use in the present invention, as well as methods for producing certain hydrosilylation reaction products, are described in, for example, U.S. Pat. No. 7,005,472 at col. 14, line 30 to col. 17, line 16, the cited portion of which being incorporated herein by reference.

As previously indicated, the polymers of the present invention are formed via a hydrosilylation reaction that is carried out in the presence of a catalytic amount of a heterogeneous platinum group metal catalyst of the type described hereinabove. As used herein, the term “catalytic amount” refers to any amount of catalyst that provides the desired increase in the rate of the hydrosilylation reaction. In certain embodiments, the catalyst is present in an amount that provides 1 to 50 ppm, such as 5 to 20 ppm, of the platinum group metal based on the total weight of the hydrosilylation reactants.

The hydrosilylation reaction may be carried out under any suitable conditions that can be readily determined by those skilled in the art. It is believed that the heterogeneous platinum group metal catalysts of the present invention can be particularly suitable for use in a continuous hydrosilylation process wherein the hydrosilylation reaction is conducted in, for example, a fixed-bed, a stirred-bed, or a fluidized-bed reactor.

The present inventors have surprisingly discovered that the heterogeneous platinum metal catalysts of the present invention, in at least some cases, have certain advantages of both a heterogeneous catalyst and a homogeneous catalyst. First, the heterogeneous platinum group metal catalysts of the present invention have shown to be removable from the resultant polymeric solution thereby minimizing, and even eliminating, the discoloration of the product. As a result, the inventors believe that the platinum (which has a yellowing effect on materials in which it is present) is bound to the carrier material such that, when the carrier is removed from the product, the platinum is also removed from the product to an extent that a clear non-yellowed material can be obtained. Moreover, the heterogeneous platinum group metal catalysts of the present invention have shown to exhibit a level of catalytic activity in a hydrosilylation reaction that can render the catalyst suitable for certain commercial applications. Without being bound by any theory, the inventors believe that this level of catalytic activity results from the affixation of the particles in a dispersed manner within and/or on the polyelectrolyte layer.

The present invention is also directed to coating compositions comprising the hydrosilylation reaction product polymer described earlier. In certain embodiments, the hydrosilylation reaction product polymer is present in the composition in an amount ranging from 0.01 to 90 percent by weight, such as 2 to 80 percent by weight, or, in some cases 10 to 30 percent by weight, with the weight percents being based on the total weight of resin solids of the components that form the composition. As used herein, the phrase “based on the total weight of resin solids” means that the amount of the component added during the formation of the composition is based on the total weight of the resin solids (non-volatiles) present during formation of the coating composition, but not including any particles or other additive solids.

In addition to the hydrosilylation reaction product polymer, the coating compositions of the present invention may comprise other components. For example, in certain embodiments, such coating compositions comprise a plurality of particles, such as any of the particles in any of the amounts described in U.S. Pat. No. 7,005,472 at col. 17, line 17 to col. 24, line 63, the cited portion of which being incorporated herein by reference.

In addition, the coating compositions of the present invention may comprise a reactant comprising a functional group that is reactive with the functional group(s), if any, present with the hydrosilylation reaction product, sometimes referred to as a curing agent. Suitable materials, and amounts, are described in U.S. Pat. No. 7,005,472 at col. 25, line 5 to col. 31, line 61, the cited portion of which being incorporated herein by reference.

In certain embodiments, the coating compositions of the present invention may further comprise a film-forming material, which is different from the hydrosilylation reaction product described earlier. Suitable film-forming materials include those materials, and amounts, described in U.S. Pat. No. 7,005,472 at col. 31, line 65 to col. 36, line 10, the cited portion of which being incorporated herein by reference.

The compositions of the present invention can be solvent-based compositions, water-based compositions, in solid particulate form, that is, a powder composition, or in the form of a powder slurry or aqueous dispersion. Thus, in certain embodiments, components of the coating compositions of the present invention are dissolved or dispersed in an organic solvent. Nonlimiting examples of suitable organic solvents include alcohols, such as butanol; ketones, such as methyl amyl ketone; aromatic hydrocarbons, such as xylene; and glycol ethers, such as, ethylene glycol monobutyl ether; esters; other solvents; and mixtures of any of the foregoing.

In solvent based compositions, the organic solvent is often present in amounts ranging from 5 to 80, such as 30 to 50, percent by weight based on total weight of the resin solids of the components which form the composition. In certain embodiments, the coating compositions have a total solids content ranging from 40 to 75, such as 50 to 70, percent by weight, based on total weight of the resin solids of the components which form the composition.

In certain embodiments, the coating compositions of the present invention also include a catalyst, which is different from the catalyst described earlier, which is present in an amount sufficient to accelerate the reaction between at least one reactive functional group of the hydrosilylation reaction product and any curing agent. Nonlimiting examples of such catalysts, and their amounts, are described in U.S. Pat. No. 7,005,472 at col. 36, lines 45 to 64, the cited portion of which being incorporated herein by reference.

In certain embodiments, additional components are present during the formation of the coating compositions of the present invention. Such materials and their amounts are described in U.S. Pat. No. 7,005,472 at col. 36, line 65 to col. 39, line 40, the cited portion of which being incorporated herein by reference.

In certain embodiments, the coating compositions of the present invention also comprise a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as phthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in United States Patent Application Publication 2005-0287348 A1, filed Jun. 24, 2004, U.S. Provisional Application No. 60/482,167 filed Jun. 24, 2003, and U.S. patent application Ser. No. 11/337,062, filed Jan. 20, 2006, which is also incorporated herein by reference.

Example special effect compositions that may be used include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain embodiments, a photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In certain embodiments, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In certain embodiments, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. application Ser. No. 10/892,919 filed Jul. 16, 2004 and incorporated herein by reference.

In general, the colorant can be present in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

As will be appreciated, the present invention is also directed to coated substrates comprising a substrate and a composition coated over at least a portion of the substrate, wherein the composition is a coating composition of the present invention as described herein. In addition, the present invention is also directed to a method of coating a substrate which comprises applying a coating composition of the present invention over at least a portion of the substrate, and, in certain embodiments, curing the composition after application to the substrate. As used herein, a composition “over at least a portion of a substrate” refers to a composition directly applied to at least a portion of the substrate, as well as a composition applied to any coating material which was previously applied to at least a portion of the substrate.

The coating compositions of the present invention can be applied over virtually any substrate including wood, ceramic, metals, glass, cloth, plastic, foam, polymeric substrates such as elastomeric substrates and the like. In certain embodiments, the present invention is directed to a coated substrate wherein the coated substrate is a flexible substrate. In other embodiments, the present invention is directed to a coated substrate as previously described wherein the coated substrate is a rigid substrate.

The present invention is also directed to a coated automobile substrate comprising an automobile substrate and a composition coated over at least a portion of the automobile substrate, wherein the composition comprises a coating composition of the present invention.

Suitable flexible elastomeric substrates can include any of the thermoplastic or thermoset synthetic materials well known in the art. Nonlimiting examples of suitable flexible elastomeric substrate materials include polyethylene, polypropylene, thermoplastic polyolefin (“TPO”), reaction injected molded polyurethane (“RIM”), and thermoplastic polyurethane (“TPU”).

Nonlimiting examples of thermoset materials useful as substrates in connection with the present invention include polyesters, epoxides, phenolics, polyurethanes such as “RIM” thermoset materials, and mixtures of any of the foregoing. Nonlimiting examples of suitable thermoplastic materials include thermoplastic polyolefins such as polyethylene, polypropylene, polyamides such as nylon, thermoplastic polyurethanes, thermoplastic polyesters, acrylic polymers, vinyl polymers, polycarbonates, acrylonitrile-butadiene-styrene (“ABS”) copolymers, ethylene propylene diene terpolymer (“EPDM”) rubber, copolymers, and mixtures of any of the foregoing.

Nonlimiting examples of suitable metal substrates include ferrous metals (e.g., iron, steel, and alloys thereof), nonferrous metals (e.g., aluminum, zinc, magnesium, and alloys thereof), and mixtures of any of the foregoing. In the particular use of automobile components, the substrate can be formed from cold rolled steel, electrogalvanized steel such as hot dip electrogalvanized steel, electrogalvanized iron-zinc steel, aluminum, and magnesium.

When the substrates are used as components to fabricate automotive vehicles (including, but not limited to, automobiles, trucks and tractors) they can have any shape, and can be selected from the metallic and flexible substrates described above. Typical shapes of automotive body components can include bodies (frames), hoods, doors, mirror housings, fenders, bumpers, and trim for automotive vehicles.

In embodiments of the present invention directed to automotive applications, the cured compositions can be, for example, the electrodeposition coating, the primer coating, the basecoat, and/or the topcoat. Suitable topcoats include monocoats and basecoat/clearcoat composites. Monocoats are formed from one or more layers of a colored coating composition. Basecoat/clearcoat composites comprise one or more layers of a colored basecoat composition, and one or more layers of a clearcoating composition, wherein the basecoat composition has at least one component which is different from the clearcoat composition. In the embodiments of the present invention directed to automotive applications, the clearcoat can be transparent after application.

In certain embodiments, the present invention is directed to multi-component composite coating compositions comprising a basecoat deposited from a pigmented coating composition, and a topcoating composition applied over at least a portion of the basecoat, wherein the topcoating composition is a coating composition of the present invention. In certain embodiments, the present invention is directed to a multi-component composite coating composition as previously described, wherein the topcoating composition is transparent after curing and is selected from any of the compositions previously described.

The basecoat and transparent topcoat (i.e., clearcoat) compositions used in the multi-component composite coating compositions of the present invention in certain instances can be formulated into liquid high solids coating compositions, that is, compositions generally containing 40 percent, such as greater than 50 percent by weight resin solids. The solids content can be determined by heating a sample of the composition to 105° C. to 110° C. for 1-2 hours to drive off the volatile material, and subsequently measuring relative weight loss.

The coating composition of the basecoat in the color-plus-clear system can be any of the compositions useful in coatings applications, such as automotive applications, and may include, for example, any of the materials described in U.S. Pat. No. 7,005,472 at col. 42, lines 24 to 58, the cited portion of which being incorporated herein by reference.

The basecoat compositions can be applied to the substrate by any conventional coating technique such as brushing, spraying, dipping, or flowing. Spray techniques and equipment for air spraying, airless spray, and electrostatic spraying in either manual or automatic methods, known in the art can be used. During application of the basecoat to the substrate, the film thickness of the basecoat formed on the substrate can range from 0.1 to 5 mils, such as 0.1 to 1 mils.

After forming a film of the basecoat on the substrate, the basecoat can be cured or alternatively given a drying step in which solvent is driven out of the basecoat film by heating or an air drying period before application of the clearcoat. Suitable drying conditions may depend on the particular basecoat composition, and on the ambient humidity if the composition is water-borne, but a drying time from 1 to 15 minutes at a temperature of 75° to 200° F. (21° to 93° C.) can be adequate.

The transparent or clear topcoat composition can be applied to the basecoat by any conventional coating technique, including, but not limited to, compressed air spraying, electrostatic spraying, and either manual or automatic methods. The transparent topcoat can be applied to a cured or to a dried basecoat before the basecoat has been cured. In the latter instance, the two coatings can then be heated to cure both coating layers simultaneously. Typical curing conditions can range from 50° F. to 475° F. (10° C. to 246° C.) for 1 to 30 minutes. Alternatively, the transparent topcoat can be cured by ionizing or actinic radiation or the combination of thermal energy and ionizing or actinic radiation as described in detail above. The clearcoating thickness (dry film thickness) can be 1 to 6 mils.

A second topcoat coating composition can be applied to the first topcoat to form a “clear-on-clear” topcoat. The first topcoat coating composition can be applied over at least a portion of the basecoat as described above. The second topcoat coating composition can be applied to a cured or to a dried first topcoat before the basecoat and first topcoat have been cured. The basecoat, the first topcoat, and the second topcoat can then be heated to cure the three coatings simultaneously.

It should be understood that the second transparent topcoat and the first transparent topcoat coating compositions can be the same or different provided that, when applied wet-on-wet, one topcoat does not substantially interfere with the curing of the other for example by inhibiting solvent/water evaporation from a lower layer. Moreover, the first topcoat, the second topcoat or both can be a coating composition of the present invention. The first transparent topcoat coating composition can be virtually any transparent topcoating composition known to those skilled in the art. The first transparent topcoat composition can be water-borne or solventborne, or, alternatively, in solid particulate form, i.e., a powder coating.

Nonlimiting examples of suitable first topcoating compositions include crosslinkable coating compositions comprising at least one thermosettable coating material and at least one curing agent. Suitable waterborne clearcoats are disclosed in U.S. Pat. No. 5,098,947, which is incorporated herein by reference, and are based on water-soluble acrylic resins. Useful solvent borne clearcoats are disclosed in U.S. Pat. Nos. 5,196,485 and 5,814,410, which are incorporated herein by reference, and include polyepoxides and polyacid curing agents. Suitable powder clearcoats are described in U.S. Pat. No. 5,663,240, which patent is incorporated herein by reference, and include epoxy functional acrylic copolymers and polycarboxylic acid curing agents.

Typically, after forming the first topcoat over at least a portion of the basecoat, the first topcoat is given a drying step in which solvent is driven out of the film by heating or, alternatively, an air drying period or curing step, before the application of the second topcoat. Suitable drying conditions will depend on the particular first topcoat composition, and on the ambient humidity if the composition is water-borne, but, in general, a drying time from 1 to 15 minutes at a temperature of 75° to 200° F. (21° C. to 93° C.) will be adequate.

In certain embodiments, the present invention is directed to a method for making a multi-component composite comprising (a) applying a pigmented composition to a substrate to form a basecoat; and (b) applying a topcoating composition over at least a portion of the basecoat to form a topcoat thereon, wherein the topcoating composition comprises a coating composition of the present invention. The topcoat can be cured, such as is described in U.S. Pat. No. 7,005,472 at col. 44, lines 29 to 43, the cited portion of which being incorporated herein by reference.

In still other respects, the present invention is directed to a method for improving the color development of a coating composition comprising a polymer comprising the hydrosilylation reaction product of a polysiloxane containing silicon hydride and an organic compound having aliphatic unsaturation in the molecule. As used herein, the term “color development” refers to the color stability of a coating composition during storage. An “improvement” in color development means that the change in color of the coating composition during storage is less relative to another coating composition. These methods comprise (a) carrying out the hydrosilylation reaction in a medium comprising a catalytic amount of a heterogeneous platinum group metal catalyst that is catalytically active towards hydrosilylation, wherein the catalyst comprises a carrier in communication with platinum group metal particles, wherein the particles are affixed to a polyelectrolyte layer; and (b) removing the catalyst from the medium.

Illustrating the invention are the following examples that are not to be considered as limiting the invention to their details. All parts and percentages in the examples, as well as throughout the specification, are by weight unless otherwise indicated.

### EXAMPLE 1

In a 3000 mL glass reaction vessel 359 parts by weight of ethylene glycol monoallyl ether, 377 parts by weight of trimethylolpropane diallyl ether, 0.06 parts by weight of sodium acetate and 1 part by weight of the supported platinum catalyst of Example 4 were agitated with a stainless steel agitator under a nitrogen atmosphere. The reactor contents were heated to 90° C. From an addition funnel 410 parts by weight of 1,1,3,3-tetramethydisiloxane were fed drop-wise into the reactor over 6 hours. After complete addition the temperature was increased to 110° C. until the reaction was complete. The endpoint of the reaction was determined by infrared spectrophotometry which indicated the Si—H functionality had been consumed. The product was filtered through #1 filter paper to yield a colorless liquid with a hydroxyl number of 279 and an APHA color of 5. The material captured on the filter paper was collected, dried and weighed. The catalyst which was recovered was 90% of the original weight added to the reactor.

### EXAMPLE 1.1

In a 3000 mL glass reaction vessel 359 parts by weight of ethylene glycol monoallyl ether, 377 parts by weight of trimethylolpropane diallyl ether, 0.06 parts by weight of sodium acetate and 1 part by weight of the supported platinum catalyst recovered from Example 1 were agitated with a stainless steel agitator under a nitrogen atmosphere. The reactor contents were heated to 90° C. From an addition funnel 410 parts by weight of 1,1,3,3-tetramethydisiloxane were fed drop-wise into the reactor over 1 hour. After two thirds of the addition was complete the addition was stopped and the temperature was increased to 110° C. The remaining one third of the addition was made over 15 minutes at 110° C. then held at this temperature until the reaction was complete. The endpoint of the reaction was determined by infrared spectrophotometry which indicated the Si—H functionality had been consumed. The product was filtered through #1 filter paper to yield a yellow liquid.

### EXAMPLE 1.2

In a 3000 mL glass reaction vessel 400 parts by weight of ethylene glycol monoallyl ether, 420 parts by weight of trimethylolpropane diallyl ether, 2.6 parts by weight of magnesium aluminosilicate, and 0.06 parts by weight of sodium acetate and 0.4 parts by weight of a solution of 5 parts by weight chloroplatinic acid hexahydrate in 63 parts by weight isopropanol were agitated with a stainless steel agitator under a nitrogen atmosphere. The reactor contents were heated to 90° C. From an addition funnel 457 parts by weight of 1,1,3,3-tetramethydisiloxane were fed drop-wise into the reactor over 2 hours. After complete addition the temperature was increased to 80° C. until the reaction was complete. The endpoint of the reaction was determined by infrared spectrophotometry which indicated the Si—H functionality had been consumed. The product was filtered through #2 filter paper to yield a yellow liquid. The material was returned to the glass reactor and treated with 5 parts by weight of magnesium aluminosilicate and 6 parts by weight of a 35% solution of hydrogen peroxide. An aliquot of the liquid was filtered to check for color and was determined visually to be clear and colorless. The materials was dried using a nitrogen sparge while holding a reaction temperature of 80° C. to remove moisture remaining from the hydrogen peroxide addition. The product was filtered through #2 filter paper under vacuum to yield a colorless liquid with a hydroxyl number of 235 and an APHA color of 5.

### EXAMPLE 1.3

A polymer was prepared using the same components, amounts, and procedures as described in Example 1.2. This product was stored for 1 year at ambient conditions in a sealed container before testing in a coating formulation as described below.

### EXAMPLE 2

In a 1000 mL glass reaction vessel 251 parts by weight of allyl glycidyl ether and 0.03 parts by weight of sodium acetate and 0.43 part by weight of the supported platinum catalyst of Example 4 were agitated with a stainless steel agitator under a nitrogen atmosphere. The reactor contents were heated to 100° C. From an addition funnel 250 parts by weight of Masil Wax Base® were fed dropwise into the reactor over 2 hours. After complete addition the temperature was increased to 110° C. until the reaction was complete. The endpoint of the reaction was determined by infrared spectrophotometry which indicated the Si—H functionality had been consumed. The product was filtered through #6 filter paper to yield a clear, colorless liquid with APHA color of <5.

### EXAMPLE 3

In a 12 L glass reaction vessel 2472 parts by weight of allyl glycidyl ether, 10.5 parts by weight of magnesium aluminosilicate and 0.3 parts by weight of sodium acetate and 2.3 parts by weight of a solution of 5 parts by weight chloroplatinic acid hexahydrate in 63 parts by weight isopropanol were agitated with a stainless steel agitator under a nitrogen atmosphere. The reactor contents were heated to 100° C. From an addition funnel 2791 parts by weight of Masil Wax Base® were fed into the reactor over 2 hours. After complete addition the temperature was maintained until the reaction was complete. The endpoint of the reaction was determined by infrared spectrophotometry which indicated the Si—H functionality had been consumed. The product was filtered through #3 filter paper to yield a clear, golden liquid with APHA color of 20-30.

### EXAMPLE 4

In a typical procedure 0.3 ml of 2M sodium hydroxide solution was added to the 5 g of alumina suspended in 25 ml of deionized water and stirred vigorously for 15 min at room temperature. Then 25 ml of 10 g×L⁻¹ poly(diallyldimethylammonium chloride) 20% aqueous solution and 0.032 g of potassium chloride was added and suspension was stirred for 1 hour again. The resulting suspension was filtered, washed with 20 ml of water and the collected solid was dried overnight at 60° C. in oven. Then solid was placed in 5 ml aqueous solution of 0.15 g (0.290 mmol) chloroplatinic acid hexahydrate and stirred for 1 hour. The metallated sample was isolated by filtration, washed with a small amount of water (about 5 ml) and dried overnight at 60° C. in oven. The dried sample was added into a flask containing 203.3 mg of hydrazine hydrate in 100 ml water. After 4 hours of stirring the product was isolated by filtration, washed several times with water and dried overnight at 60° C. About 5 g of supported catalyst was obtained as a grey powder.

### EXAMPLE 5

Coating compositions were prepared by mixing the components set forth in Table 1 in a suitable container with agitation. Amounts are reported in parts by weight.

TABLE 1

| Example | | | | | SANOL LS- | | Polymer Type and |
|---|---|---|---|---|---|---|---|
| No. | Xylene | MAK¹ | Oxsol 100² | Acetone | 292³ | DBDTA⁴ | Amount |
| 5A | 30.00 | 26.00 | 39.00 | 122.00 | — | — | Example 1.3-20.00 |
| 5B | 30.00 | 26.00 | 39.00 | 122.00 | 5.97 | — | Example 1.3-20.00 |
| 5C | 30.00 | 26.00 | 39.00 | 122.00 | — | 1.31 | Example 1.3-20.00 |
| 5D | 30.00 | 26.00 | 39.00 | 122.00 | 5.97 | 1.31 | Example 1.3-20.00 |
| 5E | 30.00 | 26.00 | 39.00 | 122.00 | — | — | Example 1.2-20.00 |
| 5F | 30.00 | 26.00 | 39.00 | 122.00 | 5.97 | — | Example 1.2-20.00 |
| 5G | 30.00 | 26.00 | 39.00 | 122.00 | — | 1.31 | Example 1.2-20.00 |
| 5H | 30.00 | 26.00 | 39.00 | 122.00 | 5.97 | 1.31 | Example 1.2-20.00 |
| 5I | 30.00 | 26.00 | 39.00 | 122.00 | — | — | Example 1-20.00 |
| 5J | 30.00 | 26.00 | 39.00 | 122.00 | 5.97 | — | Example 1-20.00 |
| 5K | 30.00 | 26.00 | 39.00 | 122.00 | — | 1.31 | Example 1-20.00 |
| 5L | 30.00 | 26.00 | 39.00 | 122.00 | 5.97 | 1.31 | Example 1-20.00 |
| 5M | 30.00 | 26.00 | 39.00 | 122.00 | — | — | Example 1.1-20.00 |
| 5N | 30.00 | 26.00 | 39.00 | 122.00 | 5.97 | — | Example 1.1-20.00 |
| 5O | 30.00 | 26.00 | 39.00 | 122.00 | — | 1.31 | Example 1.1-20.00 |
| 5P | 30.00 | 26.00 | 39.00 | 122.00 | 5.97 | 1.31 | Example 1.1-20.00 |

¹Methyl amyl ketone.
²Parachlorobenzotrifluoride solvent commercially available from Shejiang Dongyang Weihua Chem. Co., China.
³Pentamethyl-4-piperidinyl sebacate, a hindered amine light stabilizer (HALS), commercially available from Sankyo Co., New York.
⁴Dibutyl tin diacetate commercially available from Air Products & Chemicals, Inc.

The coating compositions prepared as described in Example 5 were tested for color development by placing each formulation in a metal pint paint container and storing the containers at 120° F. Initial color readings were taken before heat storage and then after 2, 4, and 8 weeks of heat storage. Color readings were made using a Orbeco-Hellige Aqua Tester commercially available from Orbeco Analytical Systems, Inc., which is a comparative color reader. Pure deionized water was used as the standard.

Results are reported as APHA color (American Public Health Association color index) in Table 2. APHA color refers to a platinum-cobalt scale color. Less change in color after 8 weeks heat storage indicates better color development.

TABLE 2

| Example | Initial | | | |
|---|---|---|---|---|
| No. | Color | 2 Week Color | 4 Week color | 8 Week Color |
| 5A | 7 | 13 | 15 | 7 |
| 5B | 7 | 13 | 15 | 7 |
| 5C | 7 | 13 | 15 | 15 |
| 5D | 7 | 15 | 23 | 25 |
| 5E | 7 | 7 | 13 | 7 |
| 5F | 7 | 7 | 13 | 15 |
| 5G | 7 | 7 | 13 | 15 |
| 5H | 7 | 15 | 28 | 30 |
| 5I | 7 | 7 | 7 | 7 |
| 5J | 7 | 7 | 13 | 7 |
| 5K | 7 | 7 | 13 | 7 |
| 5L | 7 | 7 | 13 | 7 |
| 5M | 7 | 7 | 13 | 7 |
| 5N | 7 | 7 | 13 | 7 |
| 5O | 7 | 7 | 13 | 12 |
| 5P | 7 | 10 | 20 | 25 |

It will be appreciated by those skilled in the art that changes could be made to the embodiments described above without departing from the broad inventive concept thereof. It is understood, therefore, that this invention is not limited to the particular embodiments disclosed, but it is intended to cover modifications which are within the spirit and scope of the invention, as defined by the appended claims.

We claim:

1. A heterogeneous platinum group metal catalyst comprising a carrier in communication with platinum group metal particles, wherein the particles are affixed to a polyelectrolyte layer, and wherein the catalyst is catalytically active towards hydrosilylation.

2. The catalyst of claim 1, wherein the platinum group metal particles comprise platinum particles.

3. The catalyst of claim 1, wherein the platinum group metal particles comprise ultrafine particles.

4. The catalyst of claim 1, wherein the platinum group metal particles are present in an amount of up to 3 percent by weight, based on the total weight of the catalyst.

5. The catalyst of claim 1, wherein the polyelectrolyte layer comprises poly(diallyldimethylammonium chloride).

6. The catalyst of claim 5, wherein the poly(diallyldimethylammonium chloride) has a weight average molecular weight of 400,000 to 500,000.

7. The catalyst of claim 1, wherein the polyelectrolyte is present in an amount of 6.5 to 30 percent by weight, based on the total weight of the catalyst.

8. A method for making a polymer comprising the hydrosilylation reaction product of (a) a polysiloxane containing silicon hydride and (b) an organic compound having aliphatic unsaturation in the molecule, the method comprising carrying out the hydrosilylation reaction in the presence of a catalytic amount of the heterogeneous platinum group metal catalyst of claim 1.

9. The method of claim 8, wherein the polysiloxane containing silicon hydride comprises a compound having the structure: 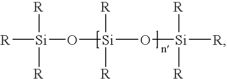
wherein each substituent group R, which may be identical or different, represents a group selected from H, OH, a monovalent hydrocarbon group, and mixtures of any of the foregoing; at least one of the groups represented by R is H, and n′ ranges from 0 to 100, such that the percent of Si—H content of the polysiloxane ranges from 2 to 50 percent.

10. A method for making the heterogeneous platinum group metal catalyst of claim 1, comprising:
(a) forming a carrier at least partially coated with the polyelectrolyte layer;
(b) adding a platinum group metal complex into the polyelectrolyte layer; and
(c) reducing the oxidation state of the platinum group metal catalyst by the addition of a reducing agent.

11. The method of claim 10, wherein the platinum group metal complex comprises H₂PtCl₆.

12. The method of claim 10, wherein the reducing agent comprises hydrazine hydrate.

13. A coating composition comprising the polymer prepared by the method of claim 8.

14. A substrate at least partially coated with the coating composition of claim 13.

15. A method for improving the color development of a coating composition comprising a polymer comprising the hydrosilylation reaction product of a polysiloxane containing silicon hydride and an organic compound having aliphatic unsaturation in the molecule, comprising:
(a) carrying out the hydrosilylation reaction in a medium comprising a catalytic amount of a heterogeneous platinum group metal catalyst that is catalytically active towards hydrosilylation, wherein the catalyst comprises a carrier in communication with platinum group metal particles, wherein the particles are affixed to a polyelectrolyte layer; and
(b) removing the catalyst from the medium.

16. A method for providing a clear polymer comprising the hydrosilylation reaction product of a polysiloxane containing silicon hydride and an organic compound having aliphatic unsaturation in the molecule, comprising:
(a) carrying out the hydrosilylation reaction in a medium comprising a catalytic amount of a heterogeneous platinum group metal catalyst that is catalytically active towards hydrosilylation, wherein the catalyst comprises a carrier in communication with platinum group metal particles, wherein the particles are affixed to a polyelectrolyte layer; and
(b) removing the catalyst from the medium.
